(19) United States
(12) Patent Application Publication
(10) Pub. No.: US 2025/0135687 A1
(43) Pub. Date: May 1, 2025

(54) WASTE SOLUTION-DYED CARPET YARN RECLAMATION AND RECYCLING SYSTEMS AND RELATED METHODS

(71) Applicant: Aladdin Manufacturing Corporation, Calhoun, GA (US)

(72) Inventors: Jonathan Wilson Skelley, Ringgold, GA (US); Paul Edward Meredith, Summerville, GA (US); Perry Michael Klouda, Trion, GA (US)

(73) Assignee: Aladdin Manufacturing Corporation, Calhoun, GA (US)

(21) Appl. No.: 18/692,268

(22) PCT Filed: Sep. 8, 2022
(86) PCT No.: PCT/IB2022/058445

§ 371 Date: Mar. 14, 2024

Related U.S. Application Data
(60) Provisional application No. 63/244,318, filed on Sep. 15, 2021.

(51) Int. Cl. B29B 17/04; B29K 67/00; B29K 105/00; B29K 105/26

(52) U.S. Cl. CPC B29B 17/0412; B29B 2017/046; B29K 2067/003; B29K 2105/0032; B29K 2105/26; B29K 2995/002; B29K 2995/0026

(57) ABSTRACT

A waste polymer recycling process may include: (1) obtaining waste polymer (e.g., waste solution dyed carpet yarn); (2) pelletizing the waste polymer; (3) obtaining green and clear polymer; (4) providing an extrusion line that includes a dosing system, an extruder, a spinning machine, and a color sensor; (5) using the dosing system to dose a first amount of the pelletized waste polymer, a second amount of the green polymer (e.g., a second amount to offset a color of the first amount of the pelletized waste polymer), and a third amount of the clear polymer into the extruder; (6) forming the extruded polymer combination into carpet yarn using the spinning machine; (7) using the color sensor to determine a color of the carpet yarn and (8) using the dosing system to adjust at least one of the amount of pelletized waste polymer, green polymer, and/or clear polymer introduced into the extruder.

### BACKGROUND

Currently, uses for waste dyed filament or yarn, (e.g. solution dyed carpet yarn), are limited as a result of the waste yarn being provided or impregnated with color. Accordingly, there is currently a need for improved methods for dealing with waste dyed filament or yarn. The same problem exists for dealing with scrap of colored plastic products other than filaments.

### SUMMARY

A method, according to various embodiments, comprises: (1) providing pellets obtained from dyed filaments, wherein the dyed filaments are obtained from a polymer; (2) providing a first plurality of flakes based on the polymer and having a first color; (3) providing a second plurality of flakes based on the polymer, the second plurality of flakes comprising substantially clear flakes; (4) forming an extrudate by commonly extruding the pellets, the first plurality of flakes, and the second plurality of flakes using an extruder; and (5) forming the extrudate into a product. In particular embodiments, the dyed filaments are derived from a dyed yarn comprising a plurality of the dyed filaments. In still other embodiments, the dyed yarn is a solution dyed yarn.

In any embodiment described herein, the polymer comprises at least one of polyethylene terephthalate (PET), polytrimethylene terephthalate (PTT), polyamide (PA), polypropylene (PP), or polyolefin. In various embodiments, the pellets described herein are exclusively obtained from similarly or equally dyed filaments. In any embodiment described herein, the first plurality of flakes is obtained from one or more waste polymer products. In particular embodiments, the second plurality of flakes is obtained from one or more waste polymer products. In some embodiments, the product comprises bulked continuous carpet filaments or staple filaments. In still other embodiments, the method further comprises forming the bulked continuous carpet filaments or staple filaments into yarn. In any embodiment described herein, the product comprises a yarn comprising a plurality of the bulked continuous filaments or the staple filaments, and the extrudate is formed into the yarn using a spinning machine operably connected to the extruder. In any other embodiment, the product comprises polymeric pellets or polymeric nurdles.

In particular embodiments, a mixture of the pellets, the first plurality of flakes and the second plurality of flakes is metered before commonly extruding the pellets, the first plurality of flakes, and the second plurality of flakes using a dosing system. In various embodiments, the method further comprises determining the color of the extrudate or the product using a color sensor, and, based on the color of the extrudate or the product, causing the dosing system to modify the mixture. In some embodiments, causing the dosing system to modify the mixture modifies at least one of the amount of pellets and/or the amount of the first plurality of flakes metered into the extruder.

A method according to various embodiments comprises forming an extrudate by extruding a mixture comprising: (1) pellets obtained from one or more dyed polymer products; (2) a first plurality of flakes having a first color; and (3) a second plurality of flakes comprising substantially clear flake. In particular embodiments, the method further comprises forming the extrudate into a new polymer product. In some embodiments, the new polymer product is based on the one or more dyed polymer products. In particular embodiments: (1) the one or more dyed polymer products have a second color; (2) the new polymer product has a third color that is distinct from the second color; and (3) the third color is based on an amount of the pellets, the first plurality of flakes, and the second plurality of flakes in the mixture. In any embodiment described herein, the method includes metering the mixture using a dosing system. In particular embodiments, the method further comprises determining a color of the extrudate or the new polymer product using a color sensor, and, based on the color of the extrudate or the new polymer product, causing the dosing system to modify the mixture by modifying at least one of: (1) a first amount of pellets in the mixture; and (2) a second amount of the first plurality of flakes in the mixture.

In any embodiment described herein, a method comprises: (1) providing a first extrusion line; (2) using the first extrusion line to produce solution dyed carpet yarn, wherein at least a portion of the solution dyed carpet yarn comprises waste solution dyed carpet yarn; (3) collecting the waste solution dyed carpet yarn; (4) pelletizing the waste solution dyed carpet yarn into recovered waste carpet pellets; (5) providing a first plurality of recycled PET flakes, the first plurality of recycled PET flakes comprising substantially green recycled PET flakes; (6) providing a second plurality of recycled PET flakes, the second plurality of recycled PET flakes comprising substantially clear recycled PET flakes; and (7) providing a second extrusion line comprising: (A) an extruder; (B) a dosing system configured to meter an amount of the recovered waste carpet pellets, the first plurality of recycled PET flakes, and the second plurality of recycled PET flakes into the extruder; and (C) a color sensor configured to determine a color of the carpet yarn. In various embodiments, the method further comprises: (1) using the dosing system to meter a mixture comprising a first amount of the recovered waste carpet pellets, a second amount of the first plurality of recycled PET flakes, and a third amount of the second plurality of recycled PET flakes into the extruder such that the second amount of the first plurality of flakes at least partially offset a color of the first amount of the recovered waste carpet pellets in the mixture; (2) at least partially purifying the polymer in the extruder, the polymer comprising the mixture; (3) forming the polymer into a new polymer product; (4) determining the color of the new polymer product using the color sensor; and (5) based on the color of the new polymer product, causing the dosing system to modify at least one of: (A) the first amount of the recovered waste carpet pellets metered into the extruder; and (B) the second amount of the first plurality of recycled PET flakes metered into the extruder.

In any embodiment described herein, the first amount of the recovered waste carpet pellets comprises up to ten percent of the mixture by weight. In still other embodiments, the second amount of the first plurality of recycled PET flakes comprises up to fourteen percent of the mixture by weight. In various embodiments, the method further comprises: (1) using the dosing system to meter the first amount of recovered waste carpet pellets in the mixture such that the first amount of recovered waste carpet pellets remains consistent; and (2) based on the color of the carpet yarn, causing the dosing system to adjust the second amount of the first plurality of recycled PET flakes metered into the extruder. In particular embodiments the first plurality of recycled PET flakes consists essentially of substantially green recycled PET flakes, and the second plurality of recycled PET flakes consists essentially of substantially clear recycled PET flakes.

A method according to particular embodiments, comprises: (1) obtaining waste dyed carpet yarn; (2) pelletizing the waste dyed carpet yarn into recovered waste pellets; (3) providing a plurality of green recycled PET flakes; (4) providing a plurality of clear recycled PET flakes; and (5) providing a second extrusion line comprising: (A) an extruder; (B) a dosing system configured to meter a mixture comprising the recovered waste pellets, the plurality of green recycled PET flakes, and the plurality of clear recycled PET flakes into the extruder; and (C) a color sensor. In any embodiment described herein, the method further comprises: (1) using the dosing system to meter the mixture into the extruder such that the plurality of green recycled PET flakes at least partially offset a color of the recovered waste pellets in the mixture; (2) at least partially purifying the polymer in the extruder, the polymer comprising the mixture; (3) forming the polymer into a new polymer product; (4) determining the color of the new polymer product using the color sensor; and (5) based on the color of the new polymer product, causing the dosing system to modify at least one of: (A) a first amount of the recovered waste carpet pellets in the mixture; and (B) a second amount of the plurality of green recycled PET flakes in the mixture. In various embodiments, the mixture comprises up to 10 percent recovered waste carpet pellets by weight. In still other embodiments, the mixture comprises between 0 percent and 2 percent recovered waste carpet pellets by weight. In various other embodiments, the mixture comprises up to 14 percent green recycled PET flakes by weight. In any embodiment described herein, determining the color of the new polymer product using the color sensor comprises determining an A value of the new polymer product in an L*a*b* color space.

In particular embodiments, determining the A value of the new polymer product in an L*a*b* color space comprises determining whether the A value is within a first range of between −4.0 and −2.6; and responsive to determining that the A value is within the first range, maintaining a ratio of the recovered waste carpet pellets, the plurality of green recycled PET flakes, and the plurality of clear recycled PET flakes in the mixture. In some embodiments, the method further comprises, responsive to determining that the A value is below the first range, causing the dosing system to increase an amount of recovered waste carpet pellets in the mixture. In still other embodiments, the method further comprises, responsive to determining that the A value is above the first range, causing the dosing system to increase an amount of the plurality of green recycled PET flakes in the mixture.

In particular embodiments, determining the A value of the new polymer product in the L*a*b* color space comprises determining whether the A value is within a second range of between −3.9 and −3.7; and the method further comprises, responsive to determining that the A value is outside the second range, causing the dosing system to modify at least one of: the first amount of the recovered waste carpet pellets in the mixture; and the second amount of plurality of green recycled PET flakes in the mixture. In any embodiment described herein, recovering the waste dyed carpet yarn from the first extrusion line comprises recovering the waste dyed carpet yarn based on a color of the waste dyed carpet yarn.

### BRIEF DESCRIPTION OF THE DRAWINGS

Having described various embodiments in general terms, reference will now be made to the accompanying drawings, which are not necessarily drawn to scale, and wherein:

FIGS. 1-5 depict high-level overviews of manufacturing processes for producing a new product from one or more dyed polymer products according to various embodiments described herein;

FIG. 6 depicts an exemplary graph showing the a*b* color range from an L*a*b* color space according to various embodiments; and

FIG. 7 depicts a process flow, according to a particular embodiment, for producing carpet yarn in a process that utilizes waste solution dyed carpet yarn.

### DETAILED DESCRIPTION OF VARIOUS EMBODIMENTS

Various embodiments will now be described in greater detail. It should be understood that the disclosure herein may be embodied in many different forms and should not be construed as limited to the embodiments set forth below. Rather, these embodiments are provided so that this disclosure will be thorough and complete, and will fully convey the scope of the disclosure to those skilled in the art. Like numbers refer to like elements throughout.

### Overview

In particular embodiments, a process for producing a new product from recycled filament comprises recycling colored filaments or yarns into the new product using a mixture of the colored filament and/or yarn together with clear and colored polymer flakes in order to steer the color of the final product. For example, by adjusting an amount of colored filament (e.g., pellets derived from the colored filament) and an amount of the clear and colored polymer flakes, the process may result in a new product with a color that is based on the amount of the colored filament, the amount of the clear polymer, and the amount of the colored polymer. In particular embodiments the amount of the colored polymer may at least partially offset a color of the colored filaments.

In various embodiments, the process for producing the new product comprises: (1) providing pellets derived from the recycled filament; (2) providing a first plurality of polymer flakes in a first color based on the color of the recycled filament; (3) providing a second plurality of polymer flakes comprising substantially clear flakes; (4) forming an extrudate by commonly extruding the pellets derived from the recycled filament, the first plurality of polymer flakes, and the second plurality of polymer flakes; and (5) forming the extrudate into the new product.

In any embodiment described herein, the recycled filament or yarn may comprise a solution dyed yarn. In still other embodiments, the recycled filament may comprise bulked continuous carpet filaments. In any embodiment described herein, the polymer may comprise one or more of: (1) polyethylene terephthalate (PET); (2) polytrimethylene terephthalate (PTT); (3) polyamide (PA); (4) polypropylene (PP); (5) polyolefin; and/or (6) any other suitable polymer.

In various embodiments, the recycled colored filaments, yarns, or pellets may be derived substantially exclusively from similarly or equally dyed filaments (e.g., such that the recycled colored filament, yarn, and/or pellets are substantially the same color. In any embodiment described herein, the first and second plurality of polymer flakes may be derived from one or more waste polymer products.

In a particular embodiment, the new product produced via the process comprises bulked continuous carpet filament, staple filament, or any other suitable product. In yet another embodiment, the new product may comprise polymeric pellets and/or nurdles.

In any embodiment described herein, a mixture or pellets derived from the recycled colored filaments, the first plurality of polymer flakes, and the second plurality of polymer flakes is metered prior to extrusion, for example, using a dosing system. In particular embodiments, the process further includes a color sensor configured to measure a color of an extrudate (e.g., an extrudate formed from the pellets, the first plurality of polymer flakes, and the second plurality of polymer flakes) and/or the new product. The process may then cause the dosing system to modify the mixture of the pellets, the first plurality of polymer flakes, and the second plurality of polymer flakes (e.g., modify an amount of one or more of the pellets, the first plurality of polymer flakes, and the second plurality of polymer flakes in the mixture) based on the measured color (e.g., to produce a new product of a different, desired color).

In a particular embodiment, a carpet yarn manufacturing process utilizes waste solution dyed carpet yarn recovered from a separate carpet yarn manufacturing process. For example, as may be understood in light of the present disclosure, carpet yarn (e.g., and other polymer yarn) produced using various solution dying techniques results in a yarn that is impregnated by color. As such, there are limited applications for which waste solution dyed carpet yarn can be recycled or re-used for one or more other applications. For example, when producing solution dyed carpet yarn, a manufacturing process may result in at least some waste solution dyed carpet yarn as a result of: (1) color changeover on a particular manufacturing line (e.g., when switching from a first color to a second color of solution dyed carpet yarn on a particular production line); (2) color variation of the produced carpet yarn (e.g., resulting from seasonal variation of a color of recycled polymer such as recycled PET that forms the base of the carpet yarn that is being solution dyed); and (3) any other suitable reason. In various embodiments, once the solution dyed carpet yarn has been impregnated with color, applications for the use of the waste yarn may be limited by the color of the yarn. For example, when producing carpet yarn, a manufacturing process will generally begin with clear (e.g., substantially clear) polymer that can be dyed into any desired color for use in a final product (e.g., carpet). As such, recovering and re-using natural yarn or other carpet yarn that has not been impregnated by color (e.g., as in the case of solution dying or deep dying) may be utilized for various applications as the natural yarn remains substantially clear. Waste solution-dyed yarn, on the other hand, may have fewer practical applications as a result of the impregnated color.

Various embodiments of a process for producing carpet yarn in a process that utilizes waste solution dyed carpet yarn are described herein. In various embodiments, the process includes: (1) obtaining waste polymer (e.g., waste solution dyed carpet yarn or other suitable polymer); (2) pelletizing the waste polymer; (3) obtaining green and clear polymer (e.g., green PET or other colored PET along with clear PET); (4) providing an extrusion line that may include a dosing system, an extruder, a spinning machine, and a color sensor; (5) using the dosing system to dose a first amount of the pelletized waste polymer, a second amount of the green polymer (e.g., a second amount to offset a color of the first amount of the pelletized waste polymer, and a third amount of the clear polymer into the extruder; (6) forming the extruded polymer combination into carpet yarn using the spinning machine (e.g., or forming the extruded polymer into any other suitable produce); (7) using the color sensor to determine a color of the carpet yarn (e.g., or other suitable product); and (8) using the dosing system to adjust at least one of the first amount of the pelletized waste polymer, the second amount of the green polymer, and the third amount of the clear polymer introduced into the extruder. In various embodiments, adjusting a relative level of pelletized waste polymer, green polymer, and/or clear polymer introduced into the extruder may enable a production of a carpet yarn (e.g., or other suitable product) of a color that is suitable for its intended purpose (e.g., of a suitable color for further color processing to produce a final product of a desired color.

### Exemplary Processes

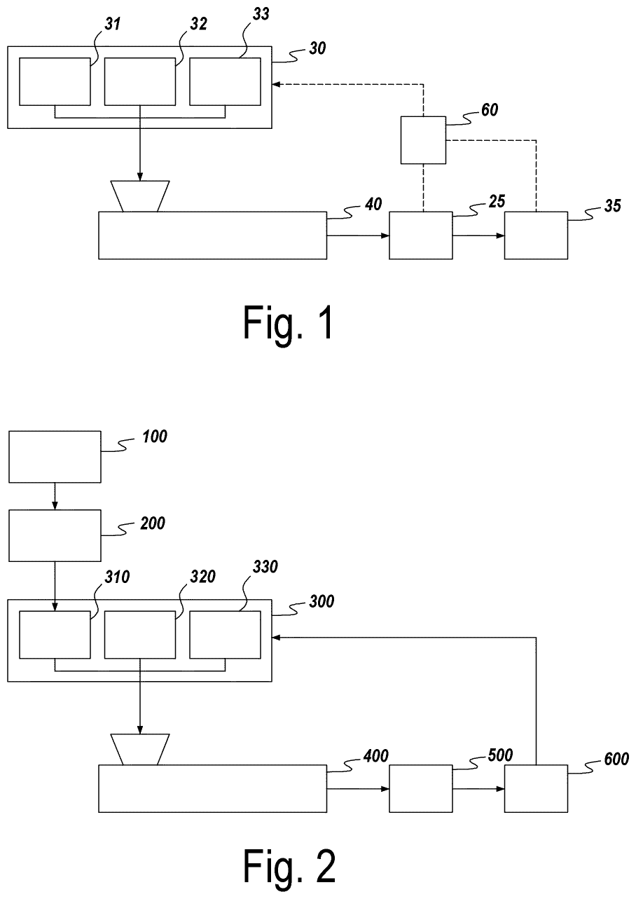

FIG. 1-5 depict high-level overviews of manufacturing processes for producing a new product from one or more dyed polymer products according to various embodiments. FIG. 1 depicts an exemplary process and method for producing a new polymer product 35 from one or more dyed polymer products 31 (e.g., one or more recycled dyed polymer products). In particular, the process involves forming an extrudate 25 by extruding a mixture 30 using an extruder 40, where the mixture 30 comprises one or more dyed polymer products 31, a first plurality of flakes 32 having a first color, and a second plurality of flakes 33 that are substantially clear. The extrudate 25 is then formed into the new product 35 using any suitable technique.

In particular embodiments, the one or more dyed polymer products 31 comprise polymer pellets derived from the one or more dyed polymer products 31. In any embodiment described herein, the new product 35 may be based on the one or more dyed polymer products 31. For example, in such embodiments, the process may involve recycling a polymer product having a first color into a new polymer product of the same type as the polymer product that has a second color. In various other embodiments, the new product 35 produced via the process comprises bulked continuous carpet filament, staple filament, or any other suitable product. In yet another embodiment, the new product 35 may comprise polymeric pellets and/or nurdles. In still other embodiments, the new product 35 may comprise one or more toys, household products, or other suitable products derived at least partially from one or more polymers.

In any embodiment described herein, the one or more dyed polymer products 31 are derived from any suitable recycled dyed polymer product (e.g., dyed filaments). In such embodiments, the dyed filaments may be derived from a dyed yarn comprising a plurality of dyed filaments (e.g., a solution dyed yarn). In any embodiment described herein, the one or more dyed polymer products 31 (e.g., which may be recycled as part of the process to form the new product 35) may include, for example, polyethylene terephthalate (PET), polytrimethylene terephthalate (PTT), polyamide (PA), polypropylene (PP), and/or polyolefin. In various embodiments, the one or more dyed polymer products 31 are formed into pellets prior to being added into the mixture 30. In some embodiments, the pellets are exclusively obtained from similarly or equally dyed products (e.g., such that the pellets that make up part of the mixture 30 are substantially uniform in color).

In a particular embodiment, the first plurality of flakes 32 may be obtained from one or more waste polymer products. In other embodiments, the second plurality of flakes 33 may be obtained from one or more waste polymer products.

In any embodiment described herein, the mixture 30 of the pellets 31, the first plurality of flakes 32, and the second plurality of flakes 33 is metered before commonly extruding the pellets, the first plurality of flakes, and the second plurality of flakes using a dosing system.

In still other embodiments, the process includes a color sensor 60 configured to detect a color of the extrudate 25 and/or the new polymer product 35. The process may, in turn, involve modifying an amount of the one or more dyed polymer products 31, the first plurality of flakes 32, and/or the second plurality of flakes 33 in the mixture 30. In a particular embodiment, a dosing system is configured to meter an amount of each of the one or more dyed polymer products 31, the first plurality of flakes 32, and/or the second plurality of flakes 33 that make up the mixture 30. In this way, the process may modify a color of the resulting extrudate 25 and/or the new polymer product 35 such that the extrudate 25 and/or the new polymer product 35 have a desired color that is derived based on a respective amount of each of the one or more dyed polymer products 31, the first plurality of flakes 32, and/or the second plurality of flakes 33 that make up the mixture.

FIG. 2 depicts an exemplary process for producing carpet yarn from waste solution dyed carpet yarn, which may, for example, include waste solution dyed carpet yarn that is recovered (e.g., recaptured) from another carpet yarn production process. As may be understood from FIG. 2, the process begins with Waste Solution Dyed Carpet Yarn 100. In particular embodiments, the Waste Solution Dyed Carpet Yarn 100 may include carpet yarn that has been pre-dyed (e.g., using one or more solution dying techniques) or has otherwise been impregnated with color such that the waste carpet yarn is unsuitable for reintroduction into a carpet yarn production process (e.g., without additional processing steps, such as those discussed herein). In particular embodiments, the Waste Solution Dyed Carpet Yarn 100 may include any other waste polymer (e.g., waste polymer other than carpet yarn, non-PET polymer waste, etc.) that has been impregnated with at least some color. In particular embodiments, the Waste Solution Dyed Carpet Yarn 100 may result from any suitable process for producing carpet yarn, and may include any suitable color of waste yarn. For example, in various embodiments, when producing carpet yarn (e.g., solution dyed carpet yarn) a process may result in at least some waste yarn as a result of: (1) color changeover on a particular manufacturing line (e.g., when switching from a first color to a second color of solution dyed carpet yarn on a particular production line); (2) color variation of the produced carpet yarn (e.g., resulting from seasonal variation of a color of recycled polymer such as recycled PET that forms the base of the carpet yarn that is being solution dyed); and (3) any other issues or changes related to a particular production process. In some embodiments, the Waste Solution Dyed Carpet Yarn 100 may result from excess yarn produced in a particular color (e.g., one or more particular colors), may be purchased as waste yarn, or may be derived from any other suitable process or source.

In particular embodiments, a process for producing carpet yarn from waste solution dyed carpet yarn may include providing, acquiring, sourcing, producing, recapturing, reclaiming, or otherwise obtaining the Waste Solution Dyed Carpet Yarn 100 for use in the process (e.g., from any suitable source discussed herein). In particular embodiments, the process may include a Pelletizing Process 200 for forming the Waste Solution Dyed Carpet Yarn 100 into pellets for use in the process. As may be understood in light of this disclosure, pelletizing the Waste Solution Dyed Carpet Yarn 100 may place the waste solution dyed polymer in better form for use in the process (i.e., because once pelletized, the waste solution dyed polymer may be introduced into the process in a more controlled manner in terms of mass and/or volume). In various embodiments, the Pelletizing Process 200 includes: (1) melting the Waste Solution Dyed Carpet Yarn 100; (2) filtering the melted Waste Solution Dyed Carpet Yarn (e.g., in order to remove one or more contaminants that may have been introduced into the Waste Solution Dyed Carpet Yarn 100 during the recovery process; and (3) pelletizing the filtered, melted Waste Solution Dyed Carpet Yarn 100 (e.g., forming the filtered, melted Waste Solution Dyed Carpet Yarn 100 into pellets). In various embodiments, the process may include pelletizing the filtered, melted Waste Solution Dyed Carpet Yarn 100 using any suitable pelletizing technique.

In various embodiments, the process may include a blending step (e.g., subsequent to or as part of the Pelletizing Process 200) for producing a blend of waste polymer pellets that is substantially the same (e.g., the same) color throughout. As may be understood in light of this disclosure, a source of waste polymer (e.g., Waste Solution Dyed Carpet Yarn 100) may include waste polymer of various colors. In particular embodiments, the blending step may be configured to reduce overall variations in color of the source waste polymer by blending the available pelletized waste polymer together. In still other embodiments, the process may include discarding at least some obtained waste polymer based at least in part on the color (i.e., because the color may be unsuitable for offsetting using the techniques described herein). As will be discussed more fully below, a more consistently colored blend of waste polymer pellets may result in a more consistent colored carpet yarn produced in a process that utilizes such waste polymer pellets. In particular embodiments, the blending step occurs in a blending silo.

Following the Pelletizing Process 200 and blending step described above, the process, in particular embodiments, utilizes a Dosing System 300 to dose a mixture comprising Solution Dyed Waste Pellets 310 (e.g., derived from the Pelletizing Process 200 discussed above), Green PET 320 (e.g., Green PET Flakes 320), and Clear PET 330 (e.g., Clear PET Flakes 330) into an Extruder 400 for melting and purifying (e.g., at least partially purifying) the mixture. In particular embodiments, the Dosing System 300 is configured to dose, into the Extruder 400, a mixture comprising: (1) up to about 10 percent Solution Dyed Waste Pellets 310 by weight; (2) up to about 14 percent Green PET 320 (e.g., Green PET Flakes 320) by weight; and (3) balance Clear PET 330 (e.g., substantially Clear PET Flakes 330) by weight (i.e., such that the remainder of the mixture comprises Clear PET 330).

In various embodiments, the mixture comprises about 10 percent Green PET 320 by weight. In any embodiment described herein, the mixture comprises about 1 percent (e.g., 1 percent) Solution Dyed Waste Pellets 310 by weight. In still other embodiments, the mixture compress about 2 percent (e.g., 2 percent) Solution Dyed Waste Pellets 310 by weight. In any embodiment described herein, the mixture may comprise between about 0 percent (e.g., 0 percent) and about 10 percent (e.g., 10 percent) Solution Dyed Waste Pellets 310 by weight. In particular embodiments, the mixture comprises between about 0 percent (e.g., 0 percent) and about 15 percent (e.g., 15 percent) Green PET 320 by weight. In other embodiments, the mixture comprises about 9 percent (e.g., 9 percent) Green PET 320 by weight.

In various embodiments, the Dosing System 300 is configured to dose an amount of Green PET 320 as part of the mixture based on an amount of Solution Dyed Waste Pellets 310 in the mixture. For example, in various embodiments, the Dosing System 300 is configured to add an amount of Green PET 320 sufficient to offset a color of the Solution Dyed Waste Pellets 310 within the mixture (e.g., offset a red coloring of the mixture from the Solution Dyed Waste Pellets 310). In still other embodiments or alternatively, the Dosing System 300 is configured to dose an amount of Solution Dyed Waste Pellets 310 as part of the mixture based on an amount of Green PET 320 in the mixture. In particular embodiments, the Dosing System 300 is configured to dose a consistent amount of Solution Dyed Waste Pellets 310 into the mixture while varying an amount of Green PET 320 in the mixture. In still other embodiment's, the Dosing System 300 is configured to dose a consistent amount of Green PET 320 into the mixture while varying an amount of Solution Dyed Waste Pellets 310 in the mixture. The Dosing System 300 may further vary an amount of Clear PET 330 based on the variance of Green PET 320 or Solution Dyed Waste Pellets 310 in the mixture.

In various embodiments, the Extruder 400 comprises any suitable extruder such as, for example, a multiple screw extruder (e.g., a Multiple Rotating Screw (“MRS”) extruder such as the MRS extruder described in U.S. Pat. No. 7,513,677, entitled “Extruder for Producing Molten Plastic Materials,”) a twin screw extruder, a single screw extruder, a multiple screw extruder, a planetary extruder, or any other suitable single or multiple screw extrusion system). In various embodiments, the Extruder 400 is configured to receive, melt, and purify the mixture (e.g., or any other suitable mixture or polymer) from the Dosing System 300. In still other embodiments, the Extruder 400 is configured to remove volatile organics and other impurities present in the mixture as well as water. In particular embodiments, the Extruder 400 is configured to reduce an intrinsic viscosity of the mixture.

In particular embodiments, following extrusion of the mixture in the Extruder 400 a melt comprising the mixture is passed to a Spinning Machine 500 (e.g., one or more spinning machines) configured to spin the melt into carpet yarn. In particular embodiments, the Spinning Machine 500 extrudes the melt comprising the mixture through small holes in a spinneret in order to produce carpet yarn filament from the melted mixture. In particular embodiments, the melted mixture cools after leaving the spinneret. The carpet yarn may then be taken up by rollers and ultimately turned into filaments that may be used to produce carpet. In particular embodiments, the Spinning Machine 500 used in the processes described herein may be a Sytec One spinning machine manufactured by Oerlika Neumag of Neumuenster, Germany. The Sytec One machine may be especially adapted for hard-to-run fibers, such as nylon or solution-dyed fibers, where the filaments are prone to breakage during processing. In various embodiments, the Sytec One machine keeps the runs downstream of the spinneret as straight as possible, uses only one threadline, and is designed to be quick to rethread when there are filament breaks. Although the example provided above describes using the Sytec One spinning machine to produce carpet yarn filament from the mixture, it should be understood that any other suitable spinning machine may be used. Such spinning machines may include, for example, any suitable one-threadline or three-threadline spinning machine, including those made by Oerlika Neumag of Neumuenster, Germany, or such machines made by any other company.

In particular embodiments, the process may further include a Color Sensor 600 (e.g., one or more color sensors) configured to determine a color of the carpet yarn produced by the Spinning Machine 500. In various embodiments, the Color Sensor 600 may comprise one or more cameras or other suitable imaging devices configured to determine a color of the carpet yarn. In a particular embodiment, the Color Sensor 600 may comprise any suitable color spectrophotometer (e.g., a suitable color Spectrophotometer produced by EQUITECH). In particular embodiments, the Color Sensor 600 may be integrated into a manufacturing line for producing carpet yarn (e.g., using one or more inline color sensors). In still other embodiments, the process may utilize one or more handheld color sensors to determine a color of the produced carpet yarn.

In particular embodiments, responsive to a measured color of the carpet yarn, the process may include modifying an amount of one or more of the Solution Dyed Waste Pellets 310 (e.g., derived from the Pelletizing Process 200 discussed above), Green PET 320 (e.g., Green PET Flakes 320), and/or Clear PET 330 (e.g., Clear PET Flakes 330) that make up the mixture fed into the upstream Extruder 400. In this way, the process may enable an adjustment of the color of the produced carpet yarn by adjusting an amount of the Solution Dyed Waste Pellets 310, Green PET 320, and Clear PET 330 that make up the mixture. For example, in response to measuring a color of the carpet yarn that is too green (e.g., using any suitable color scale), the process may involve adjusting an amount of Solution Dyed Waste Pellets 310 in the mixture (e.g., by increasing the amount of the Solution Dyed Waste Pellets 310), adjusting an amount of Green PET 320 in the mixture (e.g., by decreasing the amount of Green PET 320), etc.

In particular embodiments, the Dosing System 300 is configured to automatically modify an amount of the Solution Dyed Waste Pellets 310, Green PET 320, and/or Clear PET 330 that make up the mixture in response to measuring a particular color using the Color Sensor 600. For example, the Dosing System 330 may be operatively coupled to the Color Sensor 600 and a suitable computer controller in a computer-controlled feedback loop.

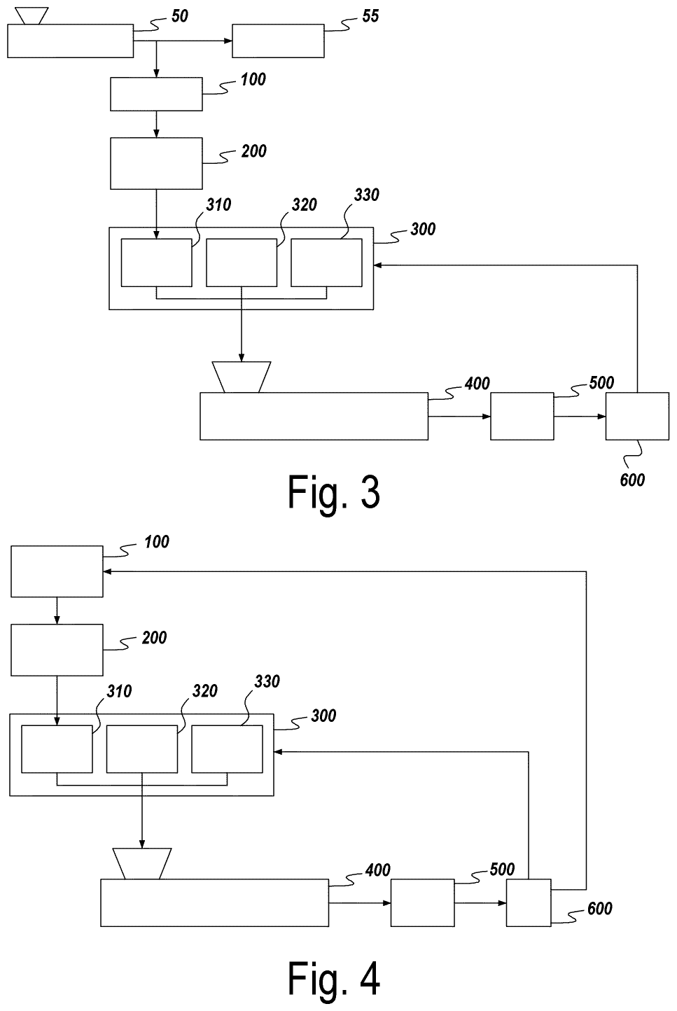

FIG. 3 depicts an exemplary process for producing carpet yarn from waste solution dyed carpet yarn according to yet another embodiment. In the embodiment shown in FIG. 3, the process may include a process similar to that shown and described with respect to FIG. 2 but may further include a first Extrusion Line 50 for producing Solution Dyed Carpet Yarn 55. As may be understood from FIG. 3, the Waste Solution Dyed Carpet Yarn 100 may be collected, recaptured, and otherwise recovered as waste carpet yarn from a primary extrusion line for use in a secondary extrusion line that utilizes the Waste Solution Dyed Carpet Yarn 100 in a secondary process that produces carpet yarn from the Waste Solution Dyed Carpet Yarn 100.

FIG. 4 depicts yet another embodiment process for producing carpet yarn from waste solution dyed carpet yarn. In the embodiment shown in FIG. 4, the Waste Solution Dyed Carpet Yarn 100 is at least partially derived from waste carpet yarn produced from the process described herein. This may include, for example, carpet yarn that is discarded based on a reading from the Color Sensor 600 as being outside of an acceptable color range. In this way, the process may be configured to capture and reuse waste solution dyed carpet yarn from other processes and sources, as well as the process described herein itself.

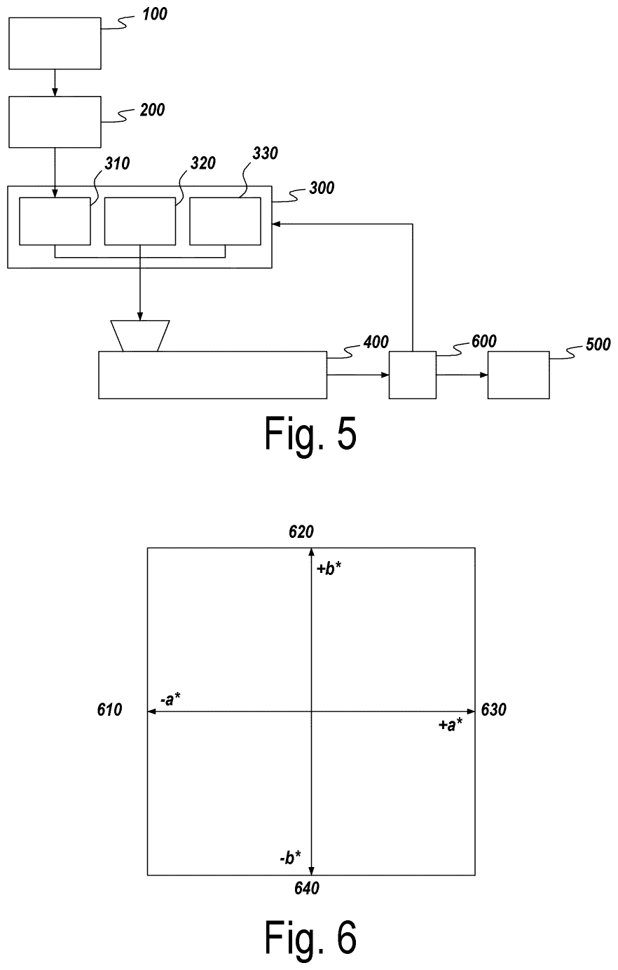

FIG. 5 depicts yet another embodiment of a process for producing carpet yarn from waste solution dyed carpet yarn. In the embodiment shown in this figure the Color Sensor 600 may be positioned in any position in the process prior to forming the molten mixture into carpet yarn using the Spinning Machine 500. For example, the process may involve determining a color of the molten polymer mixture during and/or following extrusion (e.g., using one or more color probes or other suitable devices).

### Exemplary Process Flow

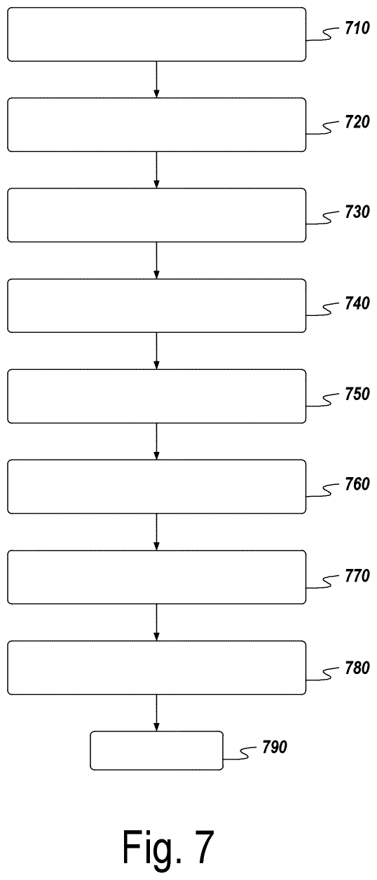

FIG. 7 depicts a process flow, according to a particular embodiment, for producing carpet yarn in a process that utilizes waste solution dyed carpet yarn. In particular embodiments the process for producing carpet yarn begins, at Step 710 by obtaining waste solution dyed carpet yarn (e.g., waste colored polymer). In various embodiments, the process for producing carpet yarn from waste solution dyed carpet yarn may include providing, acquiring, sourcing, producing, recapturing, reclaiming, or otherwise obtaining the waste solution dyed carpet yarn for use in the process. In various embodiments, the process includes obtaining any suitable waste polymer (e.g., nylon) that has been impregnated with at least some color (e.g., from any suitable dying process such as solution dying). In particular embodiments, the colored waste polymer may include colored waste polymer in any suitable form (e.g., an article of manufacture, yarn, thread, pellet, flake, etc.).

Continuing to Step 720, the process including pelletizing the waste solution dyed carpet yarn (e.g., or other colored waste polymer) into recovered waste carpet pellets. In various embodiments, pelletizing the colored waste polymer comprises: (1) melting the colored waste polymer; (2) optionally filtering the colored waste polymer (e.g., in order to remove one or more contaminants that may have be present in the colored waste polymer); and (3) pelletizing the colored waste polymer (e.g., forming the colored waste polymer into pellets). In various embodiments, the process may include pelletizing the colored waste polymer using any suitable pelletizing technique).

Next, at Step 730, the process, in various embodiments, involves providing Green PET 320 and Clear PET 330. In various embodiments, the Green PET 320 may comprise a plurality of substantially green (e.g., green) PET flakes derived from recycled PET bottles (e.g., recycled green PET bottles). In still other embodiments, the Green PET 320 may comprise substantially green (e.g., green) PET pellets (e.g., produced or obtained using any suitable source and/or method). In various embodiments, the Clear PET 330 comprises substantially clear (e.g., clear) PET flakes derived from recycled PET bottles (e.g., substantially clear PET bottles such as water bottles). In particular embodiments, alternatively or in addition to providing the green and clear PET, the process may involve obtaining the green and/or clear PET from any suitable source.

Continuing to Step 740, the process includes providing an extrusion line comprising: (1) an extruder (e.g., one or more extruders); (2) a dosing system (e.g., one or more dosing systems); (3) a spinning machine (e.g., one or more spinning machines); and (4) a color sensor (e.g., one or more color sensors). In any embodiment described herein, the extruder (e.g., one or more extruders) may, for example, include a multi-rotating screw extruder, a twin screw extruder, a single screw extruder, a multiple screw extruder, a planetary extruder, or any other suitable single or multiple screw extrusion system. In various embodiments, the extruder may be configured to receive, melt, and purify polymer (e.g., such as the colored waste polymer, green PET, clear PET, etc.). In still other embodiments, the extruder is configured to remove volatile organics and other impurities present in a polymer as well as water. In particular embodiments, the extruder is configured to reduce an intrinsic viscosity of any extruded material.

In any embodiment described herein, the extruder may comprise a vacuum pump or other suitable pressure regulation system. In particular embodiments, the extruder is coupled to a pressure regulation system configured to reduce a pressure within the extruder while the extruder is extruding the mixture of colored waste polymer, green PET, and clear PET (e.g., or other suitable polymer melt). In particular embodiments, a low-pressure vacuum in the caused by the vacuum pump (e.g., or other pressure regulation system) may remove, among other things, volatile organics present in the melted polymer as the melted polymer passes through the extruder and/or at least a portion of any interstitial water present in the melt. In various embodiments, the low-pressure vacuum removes substantially all (e.g., all) of the water and contaminants from the melt.

In particular embodiments, the dosing system is configured to meter a mixture comprising the colored waste polymer pellets, the green PET, and the clear PET into the extruder. In various embodiments, the dosing system may include any suitable granulate dosing unit (e.g., or combination of granulate dosing units). In a particular embodiment, the dosing system comprises one or more gravimetric dosing dispensers, one or more volumetric dosing dispensers, one or more optometric dosing dispensers, or other suitable dosing system. In various embodiments, the dosing system is configured to dose: (1) a first amount of the colored waste polymer pellets; (2) a second amount of the green PET; and (3) a third amount of the clear PET into the extruder (e.g., such that a mixture comprising the first amount of the colored waste polymer pellets, the second amount of the green PET, and the third amount of the clear PET is metered into the extruder). In various embodiments the dosing system is configured to meter a consistent ratio of colored waste polymer pellets, green PET, and clear PET into the extruder (e.g., such that the extruder extrudes a consistent colored melt for spinning into a consistent colored carpet yarn).

In various embodiments, the spinning machine is configured to form polymer (e.g., from the mixture) from the extruder into carpet yarn. In particular embodiments following extrusion of the mixture in the extruder, a melt comprising the mixture is passed to the spinning machine configured to spin the melt into carpet yarn. In particular embodiments, the spinning machine is configured to extrude the melt comprising the mixture through small holes in a spinneret in order to produce carpet yarn filament from the melted mixture. In particular embodiments, the melted mixture cools after leaving the spinneret. The carpet yarn may then be taken up by rollers and ultimately turned into filaments that may be used to produce carpet yarn.

In various embodiments, the color sensor is configured to determine a color of the carpet yarn. In particular embodiments, the color sensor is configured to determine a color of the carpet yarn produced by the spinning machine. In still other embodiments, the color sensor may be configured to determine a color of the mixture or melt at any other suitable part of the process. In various embodiments, the color sensor may comprise one or more cameras or other suitable imaging devices configured to determine a color of the carpet yarn. In a particular embodiment, the color sensor may comprise any suitable color spectrophotometer. In particular embodiments, the color sensor may be integrated into a manufacturing line for producing carpet yarn (e.g., using one or more inline color sensors). In still other embodiments, the process may utilize one or more handheld color sensors to determine a color of the produced carpet yarn.

Returning to Step 750, the process uses the dosing system to dose the pelletized waste polymer, green PET, and clear PET into the extruder. As discussed above, the dosing system is configured to dose each of the pelletized waste polymer, green PET, and clear PET according to a particular ratio of pelletized waste polymer to green PET to clear PET. In particular embodiments, the dosing system is configured to dose, into the extruder a mixture comprising: (1) up to about 10 percent pelletized waste polymer by weight; (2) up to about 14 percent green PET by weight; and (3) balance clear PET by weight (i.e., such that the remainder of the mixture comprises clear PET.

In various embodiments, the mixture comprises about 10 percent green PET by weight. In any embodiment described herein, the mixture comprises about 1 percent (e.g., 1 percent) pelletized waste polymer by weight. In still other embodiments, the mixture compress about 2 percent (e.g., 2 percent) pelletized waste polymer by weight. In any embodiment described herein, the mixture may comprise between about 0 percent (e.g., 0 percent) and about 10 percent (e.g., 10 percent) pelletized waste polymer by weight. In particular embodiments, the mixture comprises between about 0 percent (e.g., 0 percent) and about 15 percent (e.g., 15 percent) green PET by weight. In other embodiments, the mixture comprises about 9 percent (e.g., 9 percent) green PET by weight.

In various embodiments the dosing system is configured to meter a consistent ratio of colored waste polymer pellets, green PET, and clear PET into the extruder (e.g., such that the extruder extrudes a consistent colored melt for spinning into a consistent colored carpet yarn). In particular embodiments, the dosing system is configured to provide a consistent amount of each of the waste polymer pellets, green PET, and clear PET to the extruder. In various embodiments, the extruder is configured to at least partially purify the dosed mixture (e.g., by exposing the mixture to a low-pressure vacuum within the extruder).

Continuing to Step 760, the process involves forming the extruded mixture into carpet yarn using the spinning machine. Next, at Step 770, the process involves using the color sensor to determine a color of the carpet yarn. In various embodiments, the color sensor is configured to identify the color of the carpet yarn based on any suitable color scale.

In a particular embodiment, the color sensor is configured to measure a color of the carpet yarn based at least in part on one or more L*a*b* values of yarn in an L*a*b* color space. In a particular embodiment, determining the color of the carpet yarn using the color sensor comprises determining an A value of the carpet yarn in an L*a*b* color space. For example, as may be understood in light of this disclosure, the A value may define a color of the carpet yarn on a red-green scale. FIG. 6 depicts an exemplary a*b* range in an L*a*b* color space. As may be understood from FIG. 6, in the L*a*b* color space, the A range (e.g., from −a* values to +a* values) defines a greenness and/or redness of the yarn. For example, a measured A value in the −a* range may indicate that the carpet yarn is more green 610 than red 630, and a measured A value in the +a* range may indicate that the carpet yarn is more red 630 than green 610. As described more fully herein, the waste polymer pellets utilized may have a color that is predominately on the red scale in the L*a*b* color space (e.g., predominately in the +a* range). As such, the red color of the waste polymer pellets may be at least partially offset by the green color of the green PET (e.g., derived from recycled green PET bottles). In various embodiments, the waste polymer pellets may have a color that is well-suited for offsetting by the green color of the green PET, such that a carpet yarn produced from a mixture comprising a suitable ratio of both may be well suited for dying (e.g., after spinning) into any desired color.

In still other embodiments, determining the color of the carpet yarn using the color sensor comprises determining a B value of the carpet yarn in an L*a*b* color space. For example, as may be understood in light of this disclosure, the B value may define a color of the carpet yarn on a blue-yellow 640-620 scale. FIG. 6 depicts an exemplary a*b* range in an L*a*b* color space. As may be understood from FIG. 6, in the L*a*b* color space, the B range (e.g., from −b* values to +b* values) defines a blueness and/or yellowness of the yarn. For example, a measured b value in the −b* range may indicate that the carpet yarn is more blue 640 than yellow 620, and a measured B value in the +b* range may indicate that the carpet yarn is more yellow 620 than blue 640. In particular embodiments, the process may include adding one or more offsetting blue and/or yellow additives (e.g., by the dosing system) in order to offset an overly blue or yellow measured carpet color.

At Step 780, the process involves using the dosing system to adjust a ratio of the pelletized waste polymer (e.g., waste polymer pellets), green PET, and clear PET metered into the extruder based on the determined color. For example, the process may involve adjusting the ratio of waste polymer pellets, green PET, and clear PET in the mixture provided to the extruder by the dosing system based on the determined color. In particular embodiments, the green PET and the waste polymer pellets at least partially offset a respective color of the green PET and the waste polymer pellets (e.g., because the waste polymer pellets may have a color that is at least partially red). In various embodiments, based on the determined color of the carpet yarn, the dosing system is configured to adjust the first amount of the recovered waste carpet pellets in the mixture; and/or the second amount of the green PET in the mixture. In particular embodiments, the process involves maintaining a consistent amount of one of the waste polymer pellets and the green PET and adjusting an amount of the other of the waste polymer pellets and the green PET in the mixture based on the yarn color. For example, in response to measuring a color of the carpet yarn that is too green (e.g., using any suitable color scale), the process may involve adjusting an amount of waste polymer pellets in the mixture (e.g., by increasing the amount of the waste polymer pellets).

In a particular embodiment, determining the A value of the carpet yarn in an L*a*b* color space comprises determining whether the A value is within a first range of between −4.0 and −2.6. In such embodiments, responsive to determining that the A value is within the first range, the dosing system is configured to continue to maintain a consistent ratio of the recovered waste carpet pellets, the plurality of green recycled PET flakes, and the plurality of clear recycled PET flakes in the mixture (e.g., because an A value between a range between −4.0 and −2.6 includes an A value in a desired range). In a particular embodiment, responsive to determining that the A value is below the first range (e.g., is more green 610 than the desired range), the dosing system is configured to increase an amount of recovered waste carpet pellets in the mixture (i.e., thereby increasing a redness of the mixture). In still other embodiments, responsive to determining that the A value is above the first range (i.e., is more red 630 than desired), the dosing system is configured to increase an amount of the plurality of green PET in the mixture (e.g., or reduce an amount of waste polymer pellets while maintain the amount of green PET in the mixture).

In still other embodiments, determining the A value of the carpet yarn in the L*a*b* color space comprises determining whether the A value is within a second desired range of between −3.9 and −3.7. In any embodiment described herein, responsive to determining that the A value is outside the second desired range, the dosing system is configured to modify at least one of: (1) the first amount of the recovered waste carpet pellets in the mixture; and (2) the second amount of plurality of green recycled PET flakes in the mixture. In this way, the process may enable production of carpet yarn (e.g., or other product) having a final color that is suitable for a desired downstream use (e.g., producing carpet of a desired color, etc.).

The summary of steps is as follows:
Step 710: Obtain Waste Polymer
Step 720: Pelletize the Waste Polymer
Step 730: Obtain Green Pet and Clear Pet
Step 740: Provide an Extrusion Line Comprising: (1) A Dosing System; (2) An Extruder; (3) A Spinning Machine; and (4) A Color Sensor
Step 750: Use the Dosing System to Dose a Mixture Comprising the Pelletized Waste Polymer, Green Pet, and Clear Pet into the Extruder
Step 760: Form the Extruded Mixture into Carpet Yarn Using the Spinning Machine
Step 770: Following Extrusion, use the Color Sensor to Determine a Color of the Carpet Yarn
Step 780: Use the Dosing System to Adjust a Ratio of the Pelletized Waste Polymer, Green Pet, and Clear Pet in the Mixture Based on the Determined Color
Step 790: End

### CONCLUSION

Many modifications and other embodiments of the disclosure will come to mind to one skilled in the art to which this disclosure pertains having the benefit of the teachings presented in the foregoing descriptions and the associated drawings. In addition, it should be understood that various embodiments may omit any of the steps described above or add additional steps. Furthermore, any numerical ranges described herein are intended to capture every integer and fractional value within the described range (e.g., every rational number value within the described range).

For example, it should be understood that a range describing a letdown ration of between about two percent and about eight percent is intended to capture and disclose every rational number value percentage between two percent and eight percent (e.g., 2%, 3%, 4%, 5%, 6%, 7%, 8%, 2.1%, 2.01%, 2.001% . . . 7.999% and so on). Additionally, terms such as “about,” “substantially,” etc., when used to modify structural descriptions or numerical values, are intended to capture the stated shape, value, etc. as well as account for slight variations as a result of, for example, manufacturing tolerances. For example, the term “substantially rectangular” is intended to describe shapes that are both exactly rectangular (e.g., have four sides that meet at ninety degree angles) as well as shapes that are not quite exactly rectangular (e.g., shapes having four sides that meet at an angle in an acceptable tolerance of ninety degrees, such as 90°+/−4°).

Additionally, as may be understood in light of this disclosure, references to waste solution dyed carpet yarn should be understood in encompass any solution dyed polymer (i.e., whether waste or not) including carpet yarn and other polymer products, or raw materials. Furthermore, references to waste solution dyed carpet yarn should be understood to encompass polymer (e.g., waste polymer) that includes any suitable coloring from any suitable process (i.e., one or more processes other than solution dying). For example, it should be understood that references to solution dyed carpet yarn may encompass any colored filament or yarn. Furthermore, it should be understood that the description of exemplary processes herein referring to the use of a spinning machine to produce yarn following extrusion encompass other processes that result in any other suitable new product other than yarn (e.g., producing one or more toys, household products, or other suitable products derived at least partially from one or more polymers). For example, the extrudate obtained on the basis of said pellets, and said clear and colored flakes, may be formed into new pellets, (e.g. using water pelletizing and/or cutting). The new pellets can be used as a raw material for an injection molding process, a scattering process, and/or an extrusion process.

In accordance with a special independent aspect of the present invention, the extrudate is applied for forming toys or parts therefor, for example for the forming of toy bricks. Colored or dyed toys or parts therefor, such as toy bricks, can, in so doing be recycled by reintroducing scrap, e.g. scrap toy bricks, together with said colored and clear flakes into an extruder. It is hence clear that the present invention also concerns a method for producing a toy or a part therefor, such as a toy brick, wherein the method comprises providing polymer obtained from dyed or colored toys or parts therefor, wherein the dyed or colored toys or parts. Preferably said polymer comprises or is PET. Preferably polymer from the dyed or colored toys or parts therefor are pelletized, or otherwise formed into particulate matter, for example by grinding and/or milling; providing a first plurality of flakes based on a same polymer as said polymer obtained from the toys or parts, and having a first color; providing a second plurality of flakes based on a same polymer as said polymer obtained from the toys or parts therefore, the second plurality of flakes having a second color and/or comprising substantially clear flakes; forming an extrudate by commonly extruding the polymer obtained from the dyed or colored toys or parts therefor, the first plurality of flakes, and the second plurality of flakes using an extruder; and forming the extrudate into one or more toys or parts therefor, preferably by forming said extrudate into pellets, and using these pellets in an injection molding operation.

In general, it is clear, that in the context of the present invention, said clear and colored flakes are preferably obtained from curbside and/or deposit PET bottles.

In light of the above, it is to be understood that the disclosure is not to be limited to the specific embodiments disclosed and that modifications and other embodiments are intended to be included within the scope of the appended claims. Although specific terms are employed herein, they are used in a generic and descriptive sense only and not for the purposes of limitation.

1-18. (canceled)

19. A method comprising:
providing a first extrusion line;
using the first extrusion line to produce solution dyed carpet yarn, wherein at least a portion of the solution dyed carpet yarn comprises waste solution dyed carpet yarn;
collecting the waste solution dyed carpet yarn;
pelletizing the waste solution dyed carpet yarn into recovered waste carpet pellets;
providing a first plurality of recycled PET flakes, the first plurality of recycled PET flakes comprising substantially green recycled PET flakes;
providing a second plurality of recycled PET flakes, the second plurality of recycled PET flakes comprising substantially clear recycled PET flakes;
providing a second extrusion line comprising:
an extruder;
a dosing system configured to meter an amount of the recovered waste carpet pellets, the first plurality of recycled PET flakes, and the second plurality of recycled PET flakes into the extruder;
and
a color sensor configured to determine a color of the carpet yarn;
using the dosing system to meter a mixture comprising a first amount of the recovered waste carpet pellets, a second amount of the first plurality of recycled PET flakes, and a third amount of the second plurality of recycled PET flakes into the extruder such that the second amount of the first plurality of flakes at least partially offset a color of the first amount of the recovered waste carpet pellets in the mixture;
at least partially purifying the polymer in the extruder, the polymer comprising the mixture;
forming the polymer into a new polymer product;
determining the color of the new polymer product using the color sensor; and
based on the color of the new polymer product, causing the dosing system to modify at least one of:
the first amount of the recovered waste carpet pellets metered into the extruder; and
the second amount of the first plurality of recycled PET flakes metered into the extruder.

20. The method of claim 19, wherein the first amount of the recovered waste carpet pellets comprises up to ten percent of the mixture by weight.

21. The method of claim 20, wherein the second amount of the first plurality of recycled PET flakes comprises up to fourteen percent of the mixture by weight.

22. The method of claim 21, the method further comprising:
using the dosing system to meter the first of amount of recovered waste carpet pellets in the mixture such that the first amount of recovered waste carpet pellets remains consistent; and
based on the color of the carpet yarn, causing the dosing system to adjust the second amount of the first plurality of recycled PET flakes metered into the extruder.

23. The method of claim 19, wherein:
the first plurality of recycled PET flakes consists essentially of substantially green recycled PET flakes; and
the second plurality of recycled PET flakes consists essentially of substantially clear recycled PET flakes.

24. The method of any of claim 19, wherein the first extrusion line is the second extrusion line.

25. A method comprising:
obtaining waste dyed carpet yarn;
pelletizing the waste dyed carpet yarn into recovered waste pellets;
providing a plurality of green recycled PET flakes;
providing a plurality of clear recycled PET flakes;
providing a first extrusion line comprising:
an extruder;
a dosing system configured to meter a mixture comprising the recovered waste pellets, the plurality of green recycled PET flakes, and the plurality of clear recycled PET flakes into the extruder; and
a color sensor;
using the dosing system to meter the mixture into the extruder such that the plurality of green recycled PET flakes at least partially offset a color of the recovered waste pellets in the mixture;
at least partially purifying the polymer in the extruder, the polymer comprising the mixture;
forming the polymer into a new polymer product;
determining the color of the new polymer product using the color sensor; and
based on the color of the new polymer product, causing the dosing system to modify at least one of:
a first amount of the recovered waste carpet pellets in the mixture; and
a second amount of the plurality of green recycled PET flakes in the mixture.

26. The method of claim 25, wherein the mixture comprises up to 10 percent recovered waste carpet pellets by weight.

27. The method of claim 26, wherein the mixture comprises between 0 percent and 2 percent recovered waste carpet pellets by weight.

28. The method of claim 27, wherein the mixture comprises up to 14 percent green recycled PET flakes by weight.

29. The method of claim 28, wherein:
determining the color of the new polymer product using the color sensor comprises determining an A value of the new polymer product in an L*a*b* color space.

30. The method of claim 29, wherein:
determining the A value of the new polymer product in an L*a*b* color space comprises determining whether the A value is within a first range of between −4.0 and −2.6; and
responsive to determining that the A value is within the first range, maintaining a ratio of the recovered waste carpet pellets, the plurality of green recycled PET flakes, and the plurality of clear recycled PET flakes in the mixture.

31. The method of claim 30, further comprising:
responsive to determining that the A value is below the first range, causing the dosing system to increase an amount of recovered waste carpet pellets in the mixture.

32. The method of claim 30, further comprising:
responsive to determining that the A value is above the first range, causing the dosing system to increase an amount of the plurality of green recycled PET flakes in the mixture.

33. The method of claim 29, wherein:
determining the A value of the new polymer product in the L*a*b* color space comprises determining whether the A value is within a second range of between −3.9 and −3.7; and
the method further comprises, responsive to determining that the A value is outside the second range, causing the dosing system to modify at least one of:
the first amount of the recovered waste carpet pellets in the mixture; and
the second amount of plurality of green recycled PET flakes in the mixture.

34. The method of claim 25, wherein recovering the waste dyed carpet yarn from the first extrusion line comprises recovering the waste dyed carpet yarn based on a color of the waste dyed carpet yarn.
